(19) United States
(12) Patent Application Publication
(10) Pub. No.: US 2007/0081174 A1
(43) Pub. Date: Apr. 12, 2007

(54) Image reproduction machine book support structure

(75) Inventors: Dean Peck, Tigard, OR (US); Chris Peck, Tigard, OR (US); Everett Durst, Vancouver, WA (US); John Pollard, Lake Oswego, OR (US); Carl Andersen, Tigar, OR (US)

Correspondence Address: SALTER & MICHAELSON;THE HERITAGE BUILDING, 321 SOUTH MAIN STREET, PROVIDENCE, RI, 029037128, US

(73) Assignee: Book Support Systems, Inc.

(21) Appl. No.: 11/541,929

(22) Filed: Oct. 2, 2006

Related U.S. Application Data
(60) Provisional application No. 60/723,996, filed on Oct. 6, 2005.

(51) Int. Cl. G06K 15/12

(52) U.S. Cl. 358/1.7; 358/474

(57) ABSTRACT

A book support apparatus for use with a copier machine having a scanner that has a top support surface and including a housing having a top, horizontally disposed planar opened wall constructed and arranged for receiving and supporting a glass sheet upon which a page is placed for copying, a sloping sidewall having an edge contiguous with an edge of the top wall and extending downwardly and outwardly at an angle from the top planar wall. The housing is mounted in a position in which it overlies the top support surface by at least a predetermined fixed distance. The scanner is supported to be moved in a plane at a position below and along the housing top wall and is adapted for raising and lowering the scanner between a lowermost home position under the sloping sidewall and an elevated position during the planar movement of the scanner.

### RELATED APPLICATIONS

Priority for this application is hereby claimed under 35 U.S.C. § 119(e) to commonly owned and co-pending U.S. Provisional Patent Application No. 60/723,996 which was filed on Oct. 6, 2005 and which is incorporated by reference herein in its entirety.

### BACKGROUND OF THE INVENTION

1. Technical Field

The present invention relates generally to an image reproduction machine, such as currently available in a photocopier machine, scanner or multi-function machine, and pertains more particularly to a photocopier machine book support structure which is capable of being mounted on a new or an existing photocopier machine for making it easier to photocopy books, magazines and the like.

2. Background Discussion

The present invention is in the same general field as the copy machine book supports disclosed in, for example, U.S. Design Pat. Nos. 353,830; 353,831 and 372,264; and U.S. Pat. No. 5,526,098, all to Peck, owned by the assignee of the present application. As disclosed in these patents, the supports are mounted on new or existing photocopier machines for enabling its users to more easily photocopy books, magazines or any other publications having a spine.

As shown in Design Pat. No. 353,831, for example, the support includes a sloped surface or ramp which extends away from the copying surface of the photocopier machine, the sloped surface extending along a plane which is at an angle with respect to the horizontal copy surface. A book to be copied is placed on the support in such a manner that the spine of the book extends along the junction of the sloped surface and the copying surface. The purpose of the device is to lessen the stress on the spine of the book which is normally caused by compressing the spine against the planar copier surface.

The present invention came about as a result of a change in copier technology from using reflectors, lenses and mirrors to using a scanner. Thus, the new device provides a book support structure for copiers which use the new scanner technology.

Some modern photocopiers use CIS (Contact Image Scanner) technology, which utilizes a CCD scanner array in contact with the under side of the copyboard glass. The CIS assembly moves horizontally the length of the document to perform the scan, then returns to and parks at a home position approximately 2.5 inches to the left of the left edge of the copyboard glass. This means that the center of an open book placed face down on the copyboard glass will not be parallel to, or in contact with, the copyboard glass, causing distortion or attenuation of the image. Attempts to force the book into a flat plane result in damage to the book, and are usually not fully successful in any case.

Accordingly, among the several objects of the present invention are the provision of a book support structure for a copier machine which is capable of copying pages from a book, magazine or the like and particularly a copier machine that uses scanner technology.

Another object of the present invention is to provide such a book support structure which can be readily mounted on either a new or existing photocopier machine.

A further object of the present invention is to provide such a book support structure which is easy to install and which is cost efficient to manufacture and install.

Still another object of the present invention is to provide an improved overlying platen cover that enables an even and consistent pressure to be applied to the book regardless of the thickness of the book.

### SUMMARY OF THE INVENTION

In general, the present invention is directed to a book support structure for a copier machine and/or scanner of the type comprising a generally box shaped housing having four side walls and a generally open top, means for copying articles placed above the housing, and means for controlling the copying of articles. The book support structure comprises a top, horizontally disposed planar wall constructed and arranged for receiving and supporting a sheet of glass. The top planar wall is rectangularly shaped and has four outer edges wherein the sheet of glass is positioned adjacent to the first and second outer edges of the top wall. A first sloping side wall has an edge integrally formed with the first edge of the top wall and extends downwardly and outwardly at an angle from the top planar wall. Means are provided for mounting the book support structure on the housing of the photocopier in a position in which it overlies the open top of the housing. The arrangement is such that the book support structure enables a person to copy a page of a book by placing the spine of the book along the junction of the edge of the first side wall and the first edge of the top wall with a page of the book to be copied placed over the sheet of glass.

In another aspect of the present invention a retrofit kit for mounting the book support structure on an existing photocopier machine is further provided. The retrofit kit comprises the aforementioned book support structure, and means for raising and lowering the scanner means since the sheet of glass of the retrofit kit is spaced above the sheet of the original top wall. The scanner is elevated by the scanner assembly which is attached to the original scanner bracket and moves along underneath the sheet of glass maintaining contact with the glass for critical focus. The elevated scanner is controlled so as to return to its home position by lowering the scanner means down the book support ramp to the original home position thus allowing the machine to operate with its original full scanner movement and minimizing the leading edge deletion.

In accordance with another aspect of the present invention there is provided a book support apparatus for use with a copier machine having a scanner that has a top support surface. The book support apparatus comprises a housing having a top, horizontally disposed planar opened wall constructed and arranged for receiving and supporting a transparent sheet upon which a page is placed for copying; and at least one sloping sidewall having an edge contiguous with an edge of the top wall and extending downwardly and outwardly at an angle from the top planar wall. The housing is mounted in a position in which it overlies the top support surface by at least a predetermined fixed distance. The book support structure enables a user to copy a page of a book by placing the spine of the book along the junction of the edge of the sloping sidewall and the edge of the top wall with a page of the book to be copied placed over the transparent sheet.

Other features include means for supporting the scanner in a manner to permit the scanner to be moved in a plane at a position below and along the housing top wall and means for raising and lowering the scanner between a lowermost home position under the sloping sidewall and an elevated position during the planar movement of the scanner. The scanner may comprise a scanner assembly having an optical scanner and that is controlled so as to return the scanner to its home position by lowering the scanner down and under the sloping sidewall. The means for raising and lowering the scanner may include a drive assembly having a carriage, said drive assembly maintaining the scanner in an elevated position during the scan of a document and lowers the carriage and scanner to return them to the lower home position under said sloping sidewall.

In accordance with another embodiment of the present invention there is provided a platen apparatus for use with a copy machine to cover an item being copied by the machine and comprising: a platen cover; and means for supporting the platen cover mounted above the copy machine and that includes means to enable the platen cover to move vertically while maintaining the platen cover parallel to an open top copy surface of the copy machine. The means to enable the platen cover to move preferably includes a parallelogram linkage and a counterweight. The platen cover may include a glass platen sheet backed by a resilient layer attached thereto.

### BRIEF DESCRIPTION OF THE DRAWINGS

Other objects, features and advantages of the present invention shall now become apparent upon a reading of the detailed description thereof when considered in conjunction with the accompanying illustrative drawings, in which:

FIG. 1 is a perspective view of a photocopier machine book support structure of the present invention and illustrated as mounted on a photocopier machine;

FIG. 2 is a perspective view of the book support structure of FIG. 1 with the related platen cover in an open position and with a book supported on the book support structure;

FIG. 3 is a perspective view similar to that illustrated in FIG. 2 and further showing some of the internal mechanisms of the book support structure;

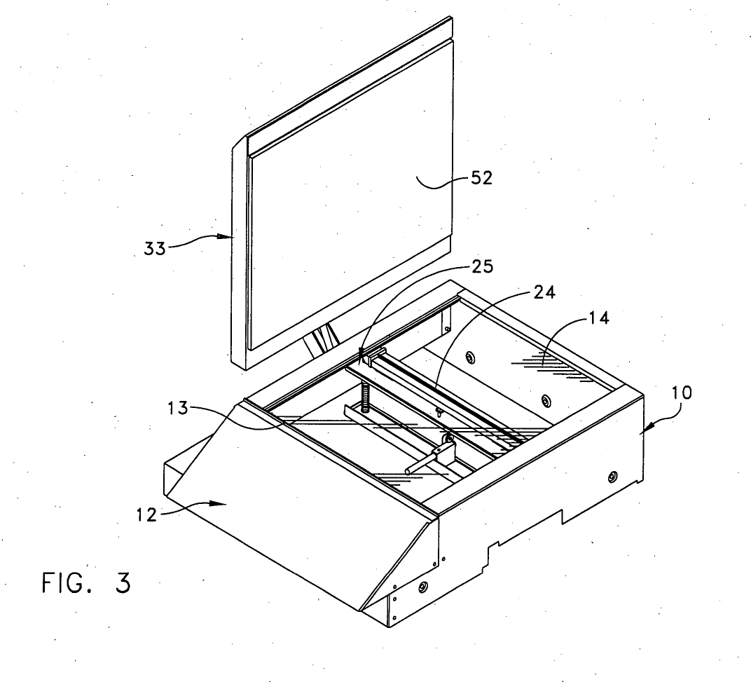

FIG. 4 is a perspective view of the book support structure with the platen placed over the book;

FIG. 5 is an exploded perspective view of the book support structure and platen cover;

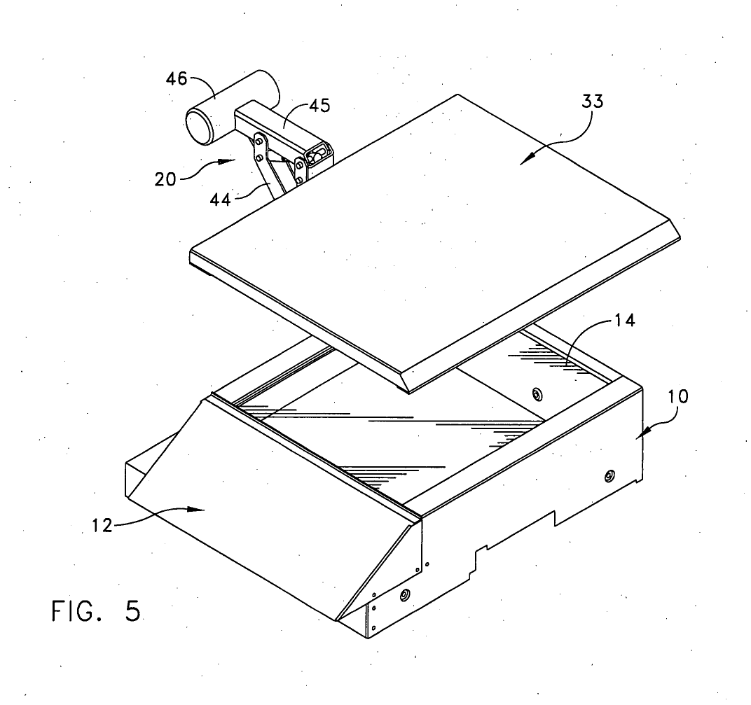

FIG. 6 is a book support structure;

FIG. 7 is an exploded perspective view illustrating the various components of the book support structure housing;

FIG. 8 is a perspective view in a cross-section illustrating further details of the book support structure;

FIG. 9 is a side elevation view illustrating one position of the scanner assembly;

FIG. 10 is an enlarged fragmentary view at the scanner assembly;

FIG. 11 is a fragmentary side elevation view similar to that illustrated in FIG. 10 and showing the scanner assembly returned to its home position;

FIG. 12 is an exploded perspective view of the components comprising the platen cover;

FIG. 13 is a side elevation view of the book support structure illustrating the platen cover in a parallel position over the book which is shown in dotted outline;

FIG. 14 is a rear view of the book support structure and platen cover of FIG. 13;

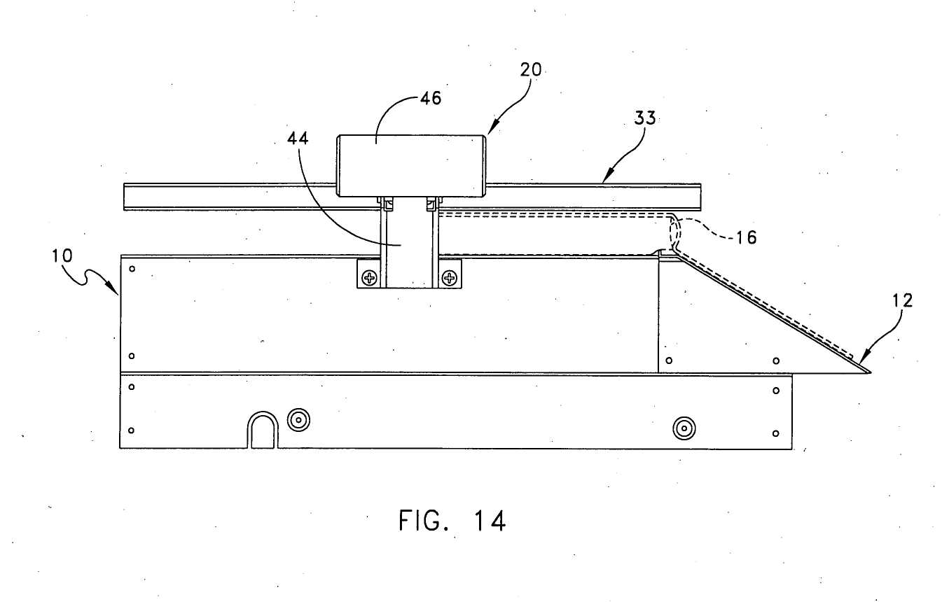

FIG. 15 illustrates the platen cover in one particular rest position in which it is maintained in a parallel position relative to the copy glass surface;

FIG. 16 illustrates a different rest position for the platen cover in which it is tilted at an angle to the copy glass surface; and

FIG. 17 illustrates the platen cover being pivotal to a fully open position.

### DESCRIPTION OF THE PREFERRED EMBODIMENT

The book support structure of the present invention replaces the original upper reader assembly frame of the copier. The left side of the case incorporates an angled support surface. The copyboard glass is meant to mount above its original position, preferably approximately 2″ to 3″ above the original position. The material used in constructing the book support structure is preferably sheet aluminum, which provides a sturdy and lightweight construction.

The book support structure of the present invention provides for a means to photocopy a bound book without placing undue stress on the binding. This is accomplished by means of two major modifications to the photocopier.

The first modification is comprised of an elevated copyboard glass in combination with a support ramp mounted on a case or housing. The return of the scanner to a position left of the beginning of the scan area would normally preclude the installation of a support ramp. The system of the present invention elevates the copyboard glass to provide space for a ramp or sloped sidewall. The copyboard is elevated to provide a position from which the ramp may descend. This ramp allows part of the book to rest below the plane of the copyboard so that the two halves of the book form an angle less acute than 180 degrees.

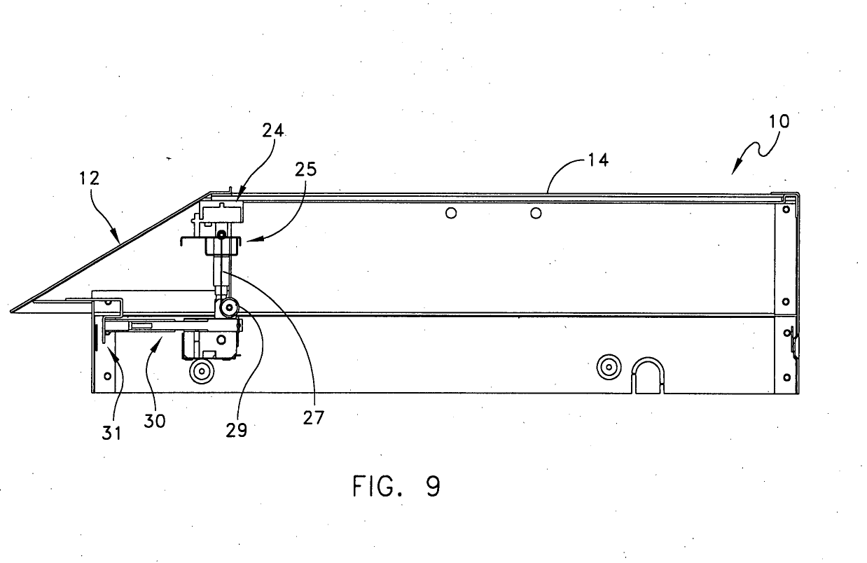

From the drawings and the following description it can be seen how the copyboard glass is elevated to provide room for the book support ramp, and how the elevation towers raise the scanner (Contact Image Scanner) carrier and scanner to the new copyboard position. This change in position (elevation) is shown, for example, in FIG. 9. The scanner lowering assembly is used because the scanner assembly preferably returns to a home position several inches to the left of the left edge of the copyboard glass. This is a consequence of the original copier design, and is not modified. Thus, associated with this first modification is a mechanism that is provided to allow the scanner to retract under the book support ramp. The same mechanism causes the scanner to rise to meet the glass when performing a scan of a document. A horizontal, spring-loaded drive rod contacts a stop near the end of the scanner travel. The rods motion is translated to a downward vertical force by means of a pulley and cable which is attached to the CIS carrier. Refer to FIGS. 9-11. This mechanism achieves the needed vertical motion without causing any sideways or downward pressure on the delicate contact image sensor, and provides for return of the scanner to the bottom of the platen glass in a controlled and gentle movement during a document scan.

A second system devised to protect the book and its binding is the platen cover assembly. A platen cover is mounted above the copyboard glass and is held in an elevated position by the action of a counterweight. The platen cover is constrained to remain horizontal while traveling vertically by a parallelogram linkage. The result is that the cover will descend under manual pressure to hold the book, maintaining an even pressure across the entire surface of the book cover. Pressure is not exerted on the spine of the book as the left edge of the platen cover is so located as to avoid contact with any part of the book resting to the left of the left edge of the copyboard glass. Further protection of the book is provided by a plastic sheet backed by rubber foam attached to the underside of the platen cover.

The book support structure of the present invention is an attachment that provides book protection, and enhances the quality of images scanned from bound books. Photocopiers on which it is installed retain all original functions, with the exception that, if the machine is provided with an automatic document feeder it has to be removed to allow for installation of the book support structure.

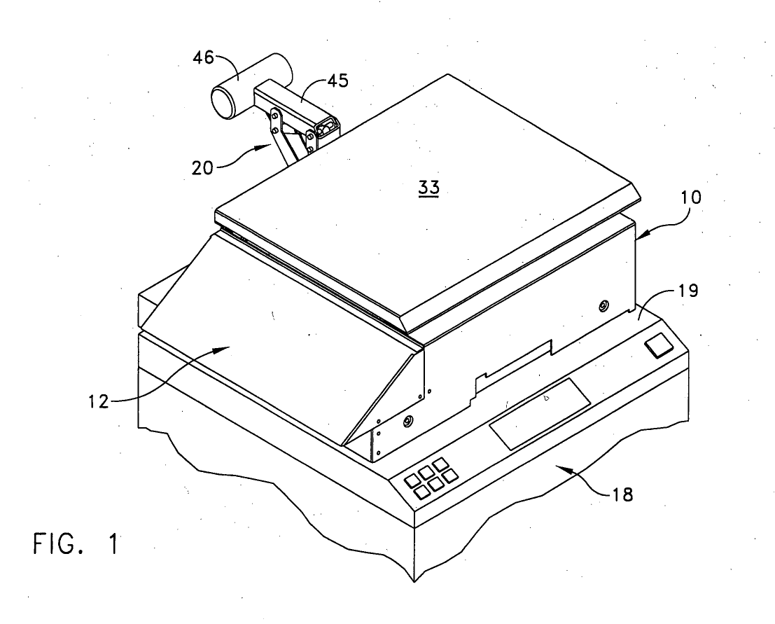

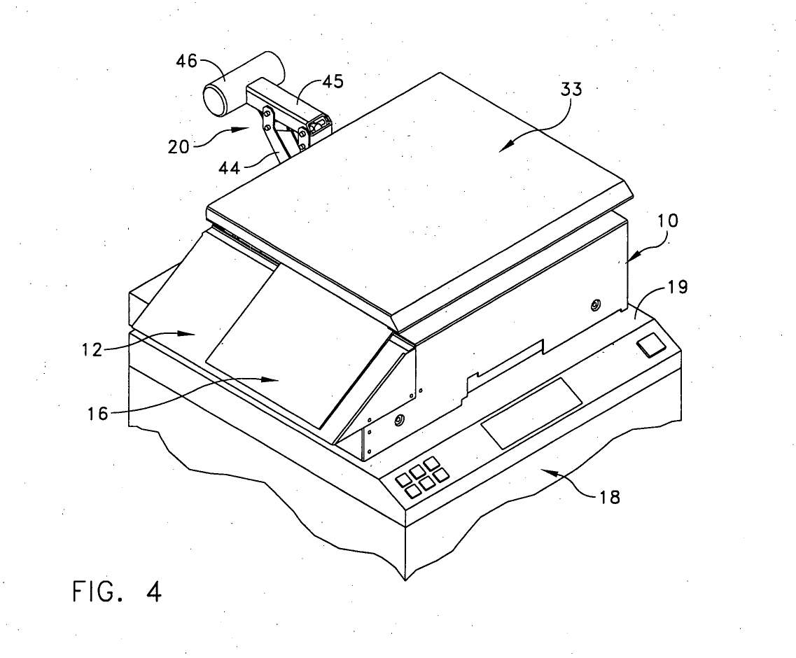

Reference is now made to the illustrated drawings. These drawings illustrate the book support structure as attached to and positioned over a copier machine. The book support structure comprises a substantially rectangular housing 10 shown in FIGS. 1 and 4 as positioned over the copier machine 18. The housing 10 rests upon the copier machine surface 19. The copier machine surface 19 normally holds the glass sheet upon which an item is placed for copying. However, in accordance with the present invention the glass is elevated to provide room for the book support ramp 12 which may be considered as being comprised of a portion of the housing 10.

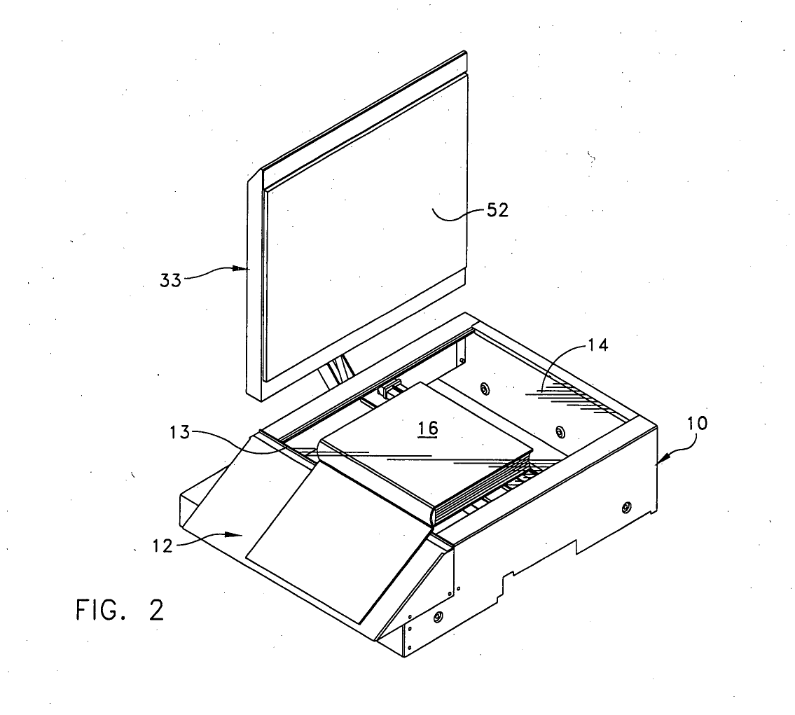

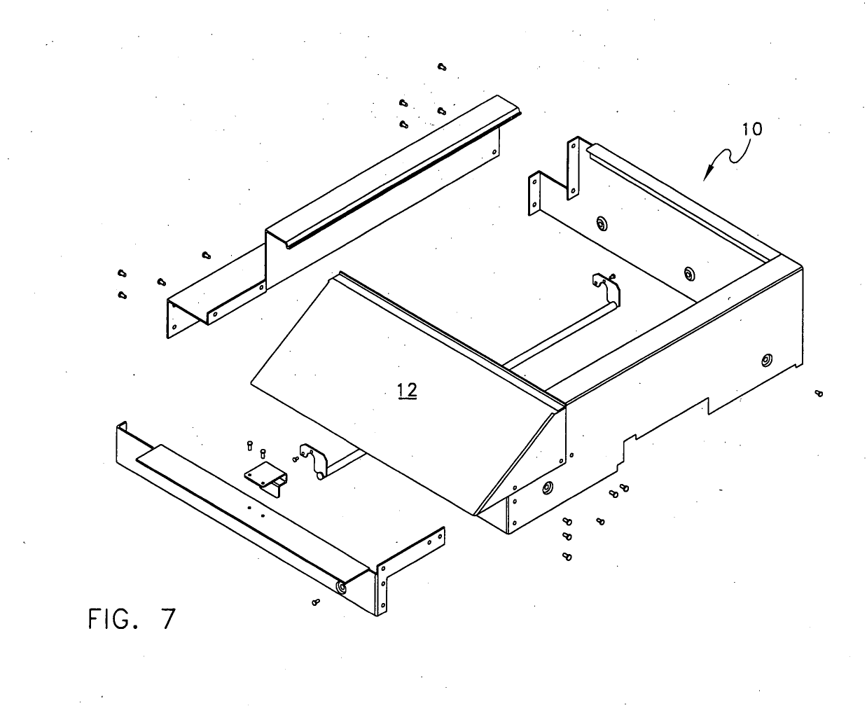

FIG. 1 also illustrates the platen cover 33. The platen cover 33 is supported from a rear of the housing 10 by means of a hinge mechanism 20 which preferably maintains the platen cover 33 in a parallel position to the top surface or glass 14 regardless of the thickness of the book that is placed on the glass for copying. FIG. 2 illustrates the platen cover 33 in a fully open position and furthermore illustrates the book 16 opened with a portion of the book placed over the glass 14 and the spine of the book in line with the edge 13 between the ramp 12 and the glass 14. FIG. 4 also illustrates the platen cover 33 in its closed position urged against the book 16 during a copying step. Refer also to the exploded perspective view of FIG. 7 which illustrates the various components of the housing 10 including a plurality of side wall members forming an open top for receiving the glass sheet 14.

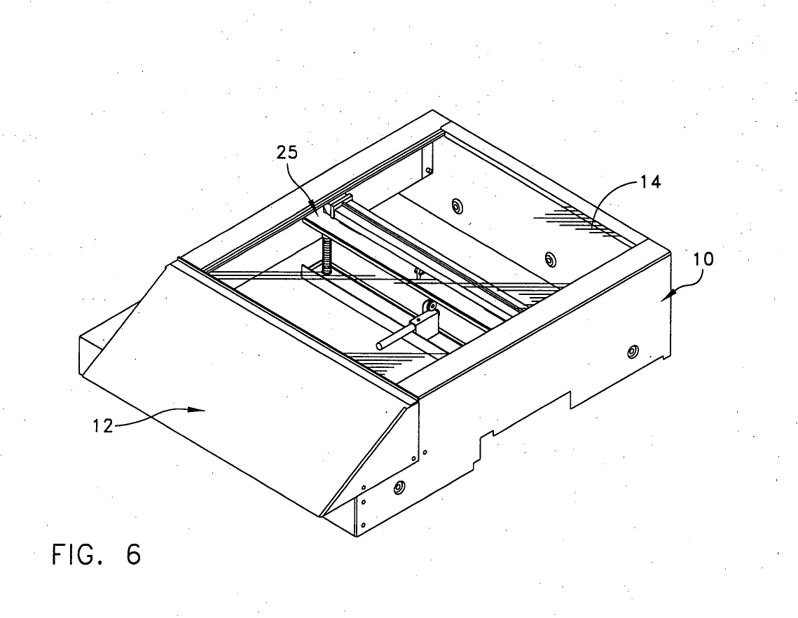

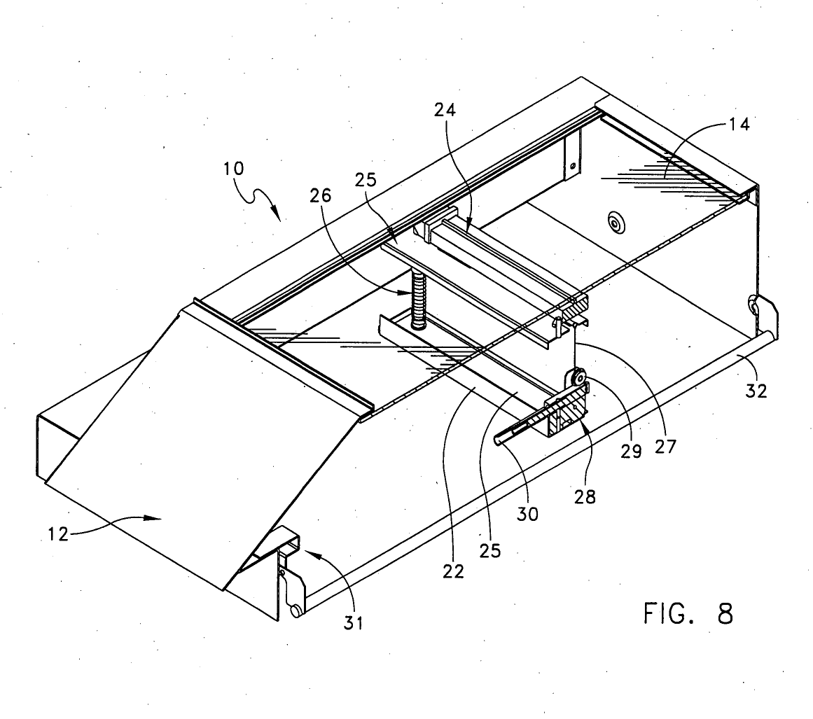

The present drawings also illustrate the other means that are employed with the book support structure in order to properly position the scanner mechanism. In this regard refer to FIGS. 6 and 8-11 for further details of the modifications to the scanner mechanism. In order to elevate the scanner so that it is adjacent to the copy glass 14, there are provided spaced tower assemblies 26. These tower assemblies extend between a base 22 and a carrier or carriage 25 for the scanner 24. The carriage 25 and base 22 are meant to transition together relative to the copy glass during a copying sequence. The cutaway perspective view of FIG. 8 illustrates the scanner in an elevated upper position adjacent to the glass 14.

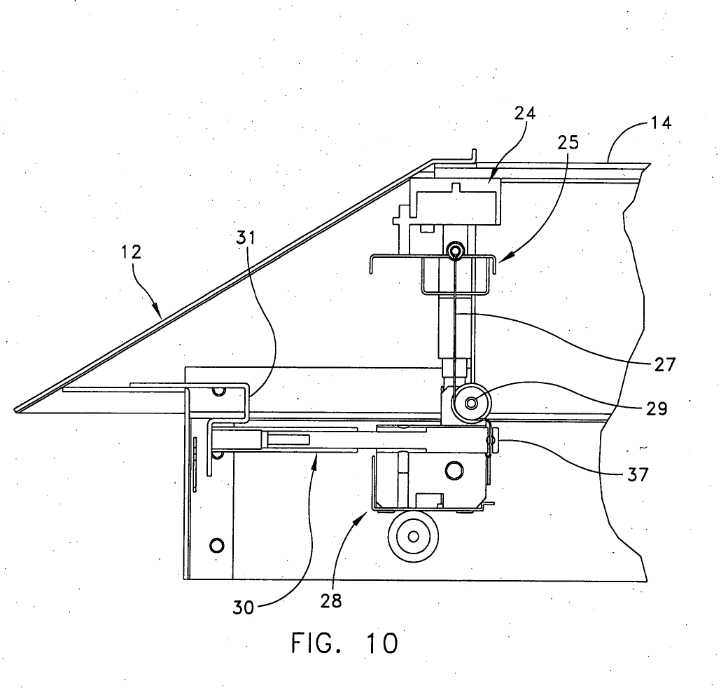

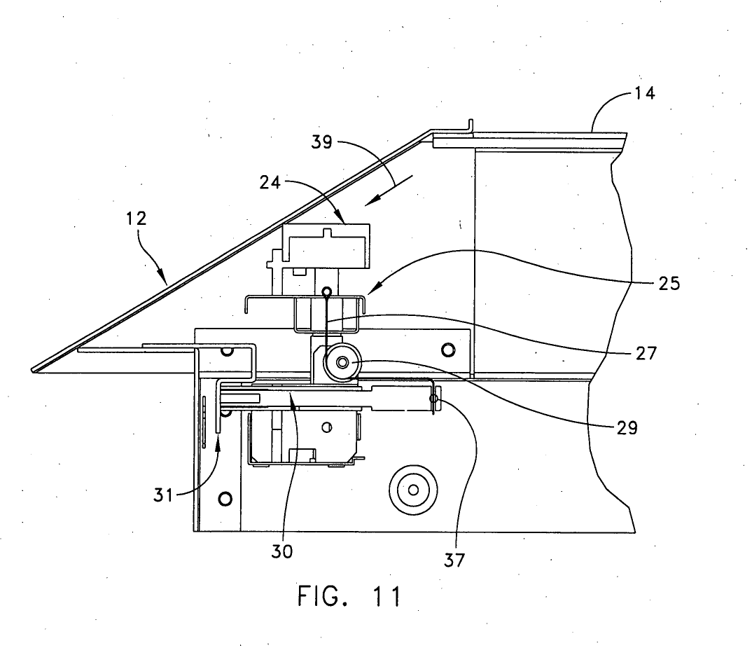

In order to lower the scanner, such as to the position illustrated in FIG. 11, there is provided a drive rod housing 28 that supports the drive rod 30. The drive rod 30 is supported for relative translation in the housing 28. Part of this lowering mechanism also includes the cable 27, the pulley 29 and a drive rod stop 31. In the position illustrated in FIG. 8 it is noted that the drive rod 30 is not in contact with the stop 31. Springs associated with the tower mechanisms 26 bias the carriage 25 upwardly and thus maintain the scanner 24 in a proper position just under the glass sheet 14. The side elevation view of FIG. 9 still illustrates the scanner 24 in its uppermost position. At the left end of the glass sheet, the scanner is still maintained at the same position and the drive rod 30 is out of engagement or is just about to engage the stop 31. Refer also to the enlarged view of FIG. 10.

FIG. 10 also illustrates the cable 27 extending about the pulley 29 and terminating at point 37 on the drive rod housing. The drive rod 30 is adapted to move in the housing 28. In the position illustrated in FIG. 1 as the scanner carriage 25 (and base 22) moves to the left, the scanner 24 is moved downwardly as illustrated by the arrow 39. This action occurs by means of the drive rod 30 engaging the stop 31 and causing the cable 27 to pull about the pulley 29 lowering the carriage 25 and the scanner 24 that is supported therefrom. FIG. 11 illustrates the scanner in its normal “rest” or “home” position. Thus, the drive rods motion is translated into a downward vertical force by means of the cable and pulley arrangement which is attached to the carrier. This mechanism achieves the needed vertical motion without having any sideways or downward pressure on the delicate contact image sensor, and provides for the return of the scanner to the bottom of the glass platen in a controlled and gentle movement when the scanner is subsequently moved to the right.

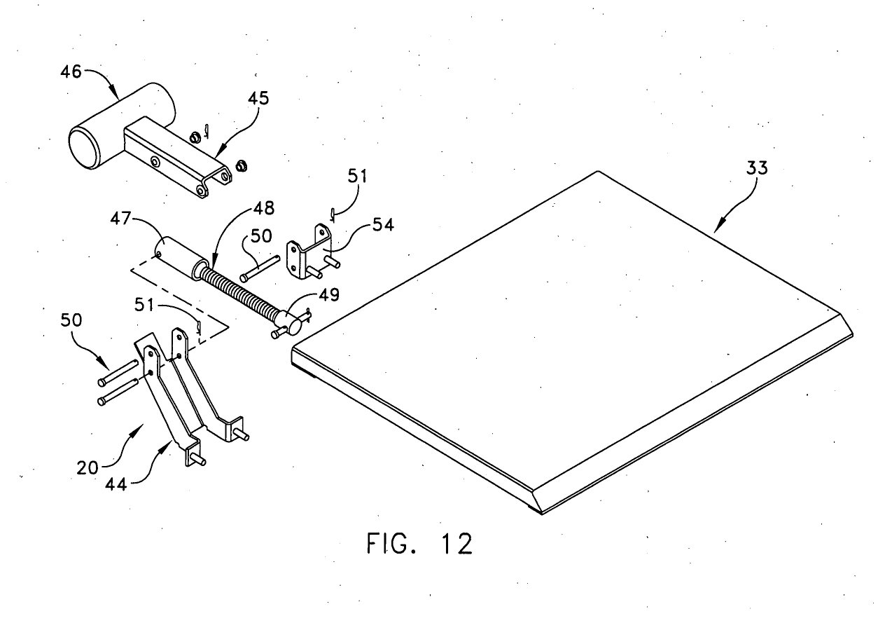

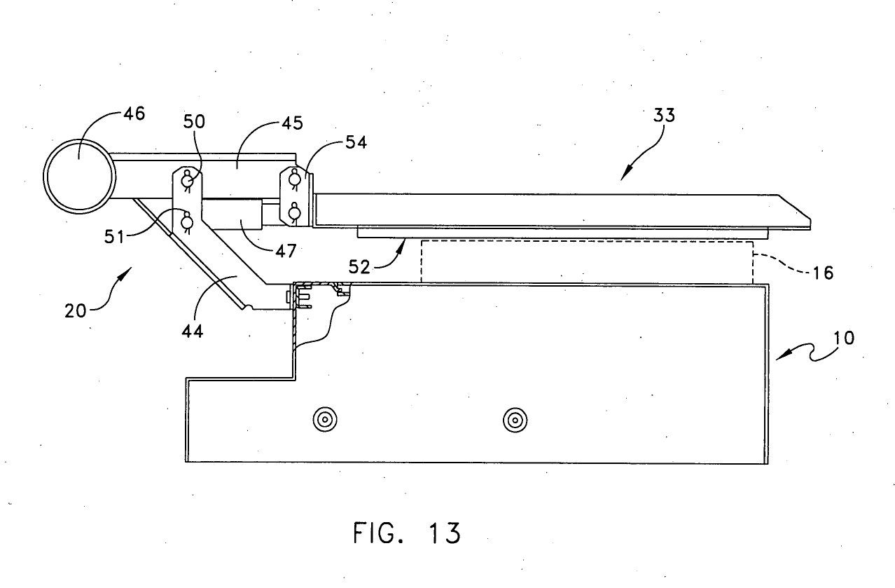

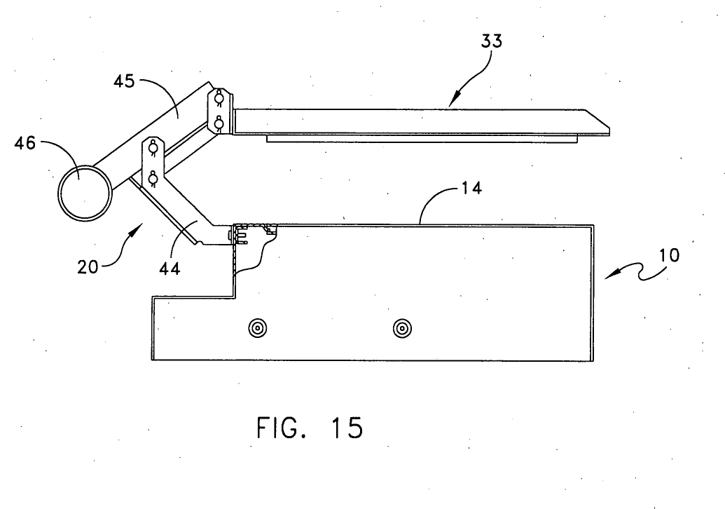

The platen cover 33 is mounted above the copyboard in glass 14 and is held in an elevated position primarily by the action of the counterweight 46. Different rest positions for the platen cover 33 are shown in respect to FIGS. 15, 16 and 17. The preferred construction is shown in FIG. 15 wherein the platen cover 33 is initially biased to an open position but one in which the platen cover 33 is substantially parallel to the surface of the glass sheet. The counterweighted, spring-loaded cover is meant to be manually lowered onto the book being copied such as to the position shown in FIG. 4 thus maintaining an attitude that is parallel to the glass and the plane of the book. This evenly distributes pressure across the whole upper surface of the book and avoids damage that might be caused by the leverage of a hinged-style cover. As mentioned previously, the parallel motion of the platen cover is provided by the hinge mechanism 20 which is in the form of a parallelogram linkage comprised of upper and lower hinge brackets 44 and 45, the counterweight 46, and a spring-loaded piston and cylinder assembly which functions as the lower link of the parallelogram. For further details of the hinge mechanism 20 refer to FIGS. 12 and 13.

In addition to the brackets 44 and 45, the parallelogram linkage also includes the spring assembly which is comprised of the spring cylinder 47, the spring 48 and the cover piston 49. The exploded perspective view of FIG. 12 shows these components and also illustrates clevis pins 50 and hitch pins 51 that are used for interconnecting the components in the manner illustrated in FIG. 13. A further bracket 54 is used for attachment of the bracket 45 and piston 49 to the platen cover 33. As illustrated in FIG. 13, the lower end of the bracket 44 is connected to the book support structure by appropriate means. FIG. 13 illustrates the attachment of the platen cover assembly to the case or housing. Also illustrated is an additional protection for the book provided by a foam-backed plastic or rubber sheet 52 attached to the underside of the rigid platen cover.

The platen cover spring assembly serves two purposes. First, it operates as a rigid (under compression) lower link of the platen cover parallelogram mechanism. Secondly, it functions to raise the front of the platen cover by spring pressure when the cover is at rest in its fully elevated position, providing better access to the book and the copyboard area.

FIG. 13 illustrates the hinge mechanism 20 in a position wherein the user has manually engaged the top surface of the platen cover 33 and has pressed the platen cover 33 against the book 16 which is illustrated in dotted outline in FIG. 13. On the other hand, the rest position of the platen cover 33 may assume a number of different positions and preferably assumes the position illustrated in FIG. 15 wherein, in the “rest” position, the platen cover 33 is maintained still at a parallel relationship to the copy glass surface. FIG. 15 shows how the counterweight 46 has pivoted the parallelogram linkage to a position where the platen cover 33 is still parallel to the glass copy surface.

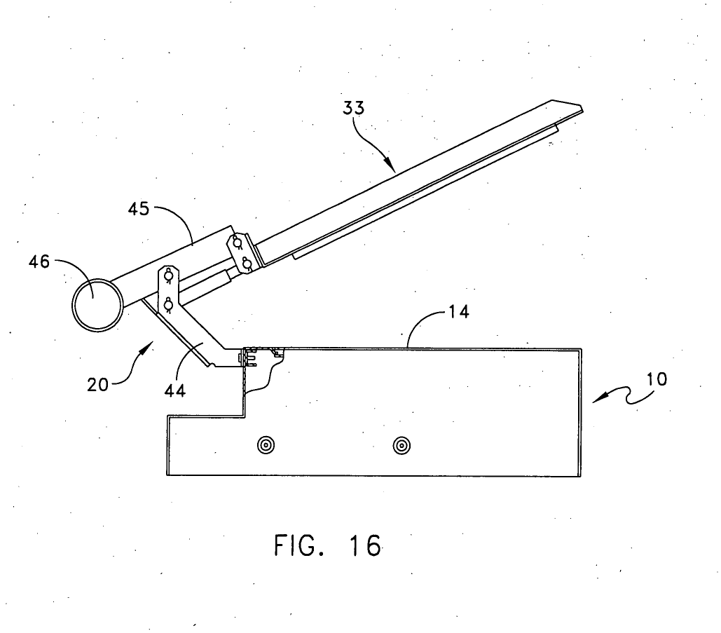

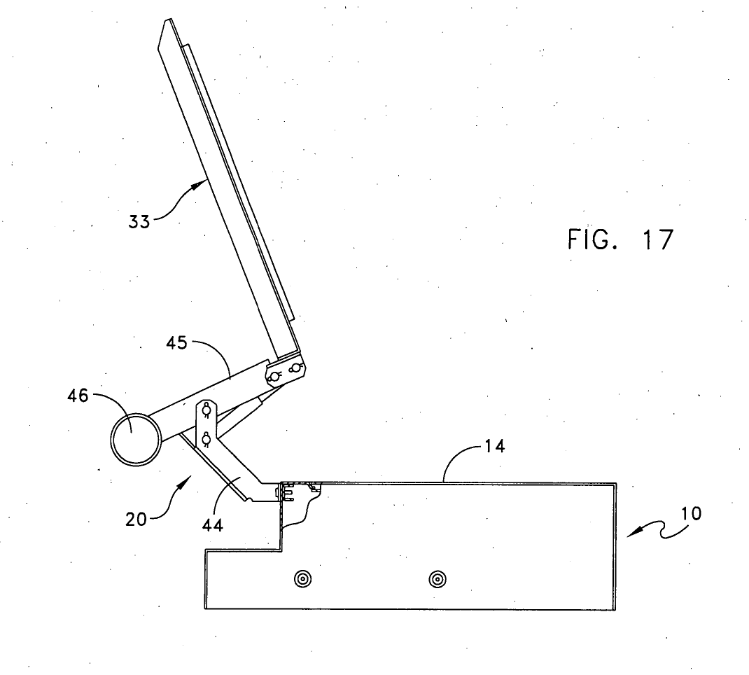

The initial rest position is determined by a number of different factors including the particular weight of the counterweight 46, the spring rating of the spring 48, and the weight of the platen cover 33. If a lighter weight platen cover 33 is used then the platen cover 33 may assume the position illustrated in FIG. 16 with the platen cover, in its rest position, in a somewhat tilted position. The parallelogram structure is also designed so that the platen cover may also be moved to a more open position such as illustrated in FIG. 17 so as to be positioned out of the way if needed.

Having now described a limited number of embodiments of the present invention, it should now be apparent to those skilled in the art that numerous other embodiments and modifications thereof are contemplated as falling within the scope of the present invention as defined by the appended claims. One modification that can be used is to provide more than one book support ramp. This may be provided in a manner disclosed in U.S. Pat. No. 5,526,098 the contents of which are hereby incorporated by reference in their entirety herein. These two separate ramp surfaces would be provided on orthogonal sides of the book support structure.

What is claimed is:

1. A combination book support structure and copier machine and/or scanner comprising:
said copier machine and/or scanner including a box shaped housing having four side walls and a generally open top;
means for copying articles placed above the housing;
means for controlling the copying of articles;
said book support structure comprising a top, horizontally disposed planar opened wall constructed and arranged for receiving and supporting a sheet of glass;
at least a first sloping side wall having an edge contiguous with a first edge of the top wall and extending downwardly and outwardly at an angle from the top planar wall;
means for mounting the book support structure on the housing in a position in which it overlies the open top of the housing by at least a predetermined distance;
said book support structure enabling a person to copy a page of a book by placing the spine of the book along the junction of the edge of the first side wall and the first edge of the top wall with a page of the book to be copied placed over the sheet of glass.

2. The combination of claim 1 wherein said sloping sidewall edge is integrally formed with the first edge of the top wall.

3. The combination of claim 1 wherein the top planar wall is rectangularly shaped and has four outer edges and wherein the sheet of glass is positioned adjacent to the first and second outer edges of the top wall.

4. The combination of claim 1 wherein said means for copying includes a scanner, a carrier and means for controlling said carrier and thus the position of said scanner between rest and elevated locations.

5. The combination of claim 4 wherein said means for controlling said carrier includes a drive assembly that maintains the scanner in an elevated position during the scan of a document and lowers the carriage and scanner to return them to a lower rest position under said sloping sidewall.

6. The combination of claim 5 wherein said drive assembly includes a drive rod, a drive rod housing for supporting the drive rod, a drive rod stop engageable with said drive rod, elevation tower means and a pulley arrangement responsive to said drive rod to change the position of said carrier.

7. The combination of claim 1 further including a platen cover that is mounted above the open top and that includes means to enable the platen cover to move vertically while maintaining the platen cover parallel to the open top copy surface.

8. The combination of claim 7 wherein said means to enable the platen cover to move includes a parallelogram linkage and a counterweight.

9. A retrofit kit for mounting a book support structure that includes a sloped support surface on an existing photocopier machine that includes a scanner means having a scanner copy surface for copying documents, said kit comprising:
means for supporting the scanner means in a manner to permit the scanner means to be moved in a plane at a position below and along the scanner copy surface;
means for raising and lowering the scanner means between a lowermost rest or home position under the sloped support surface of the book support structure and an elevated position during the planar movement of the scanner means along the scanner copy surface.

10. The retrofit kit of claim 9 wherein said scanner copy surface is defined by at least a glass sheet that is spaced above the plane of the top of the existing photocopier machine.

11. The retrofit kit of claim 9 wherein the scanner means comprises a scanner assembly having an optical scanner and that is controlled so as to return the scanner to its home position by lowering the scanner down and under the sloped support surface of the book support structure.

12. The retrofit kit of claim 9 wherein said means for raising and lowering the scanner means includes a drive assembly having a carriage, said drive assembly maintaining the scanner in an elevated position during the scan of a document and lowers the carriage and scanner to return them to a lower rest position under said sloped support surface.

13. The retrofit kit of claim 12 wherein said drive assembly includes a drive rod, a drive rod housing for supporting the drive rod, a drive rod stop engageable with said drive rod, elevation tower means and a pulley arrangement responsive to said drive rod to change the position of said carrier.

14. The retrofit kit of claim 9 further including a platen cover that is mounted above the open top and that includes means to enable the platen cover to move vertically while maintaining the platen cover parallel to the open top copy surface.

15. The retrofit kit of claim 9 wherein said means to enable the platen cover to move includes a parallelogram linkage and a counterweight.

16. A book support apparatus for use with a copier machine having a scanner that has a top support surface, said book support apparatus comprising:
a housing having a top, horizontally disposed planar opened wall constructed and arranged for receiving and supporting a transparent sheet upon which a page is placed for copying;
at least one sloping sidewall having an edge contiguous with an edge of the top wall and extending downwardly and outwardly at an angle from the top planar wall;
said housing mounted in a position in which it overlies the top support surface by at least a predetermined fixed distance;
said book support structure enabling a user to copy a page of a book by placing the spine of the book along the junction of the edge of the sloping sidewall and the edge of the top wall with a page of the book to be copied placed over the transparent sheet.

17. The book support apparatus of claim 16 further including means for supporting the scanner in a manner to permit the scanner to be moved in a plane at a position below and along the housing top wall and means for raising and lowering the scanner between a lowermost home position under the sloping sidewall and an elevated position during the planar movement of the scanner.

18. The book support apparatus of claim 16 wherein the scanner comprises a scanner assembly having an optical scanner and that is controlled so as to return the scanner to its home position by lowering the scanner down and under the sloping sidewall.

19. The book support apparatus of claim 16 wherein said means for raising and lowering the scanner includes a drive assembly having a carriage, said drive assembly maintaining the scanner in an elevated position during the scan of a document and lowers the carriage and scanner to return them to the lower home position under said sloping sidewall.

20. A platen apparatus for use with a copy machine to cover an item being copied by the machine and comprising:
a platen cover; and
means for supporting the platen cover mounted above the copy machine and that includes means to enable the platen cover to move vertically while maintaining the platen cover parallel to an open top copy surface of the copy machine.

21. The platen apparatus of claim 20 wherein said means to enable the platen cover to move includes a parallelogram linkage and a counterweight.

22. The platen apparatus of claim 20 wherein said platen cover includes a platen sheet backed by a resilient layer attached thereto.
